(19) United States
(12) Patent Application Publication
(10) Pub. No.: US 2011/0208359 A1
(43) Pub. Date: Aug. 25, 2011

(54) Assigning Scenarios to Command Buttons

(75) Inventors: Isabelle Duchene, Marignier (FR); Eric LaGarde, Sallanches (FR); Mickaël Mugnier, Bonneville (FR)

(73) Assignee: Somfy SAS, Cluses (FR)

(21) Appl. No.: 13/035,574

(22) Filed: Feb. 25, 2011

(30) Foreign Application Priority Data
Feb. 25, 2010 (FR) 1051348

(51) Int. Cl. G05B 19/02

(52) U.S. Cl. 700/275

(57) ABSTRACT

A method of controlling an installation formed by a plurality of home automation equipment items linked to a building, and handling therein, depending on the type of home automation equipment item, thermal and visual comfort functions, such as heating and air conditioning, natural ventilation, lighting, solar protection functions, and/or security functions, such as closure and/or alarm functions, the home automation equipment items communicating over one and the same home automation network. A programmable remote control implementing the control method.

This application claims priority benefits to French Patent Application Number 10 51348 filed Feb. 25, 2010, the disclosure of which is incorporated herein by reference.

### BACKGROUND OF THE INVENTION

The invention relates to the field of wireless remote control of home automation equipment items handling comfort and/or security functions in a building. Such equipment items are, for example, solar protections, roller blinds, closures, luminaries, heating or air conditioning means, fire or theft alarm devices.

When the number of equipment items becomes important, it is known to control the latter not individually but by scenarios. For a scenario, there is a corresponding sending of commands to the equipment items or at least some of them, in order to arrange each in a predefined configuration, for example stored in a control means. This configuration is, for example, an open or closed position, an intermediate position, a lighting level, a setpoint temperature, an activation or a deactivation of the alarm system.

A scenario is therefore defined by the identifiers of the equipment items concerned and by the configuration of each of them, in relation to said scenario, such information items being, for example, contained in a table of the memory of the control means.

The control means is usually a complex device, since it has to make it possible not only to activate scenarios but also to store them, which generally necessitates a sophisticated human-machine interface, of the keyboard and screen type, in order to select the various equipment items involved in the scenario and assign them the chosen configuration.

### DESCRIPTION OF THE PRIOR ART

In the field of universal remote controls for multimedia appliances (televisions and similar), it is known to simplify the construction of the remote control by assigning it a limited number of control keys.

For example, the U.S. Pat. No. 5,243,430 describes a universal remote control that has only four control keys, infrared emitters for emitting omnidirectionally and an infrared receiver for receiving, in a learning mode, the codes sent by the original remote control.

Similarly, the patent application US 2005/0174253 describes a disk-shaped remote control representing a “Smiley” face, equipped with a single control key. The patent application US 2008/0172695 also describes a disk-shaped remote control with an elliptical profile.

These devices are programmed from existing remote controls: the universal remote control does nothing more than store, in order to reproduce it thereafter, a signal sent by an original remote control of the equipment item, when a key of the original remote control is pressed.

In the case of remote controls that, on the contrary, have a complex control interface, it is known to use the facilities offered by a personal computer to serve as programming means.

The U.S. Pat. No. 6,909,378 describes a method for assisting the key-to-key programming of a universal remote control that has numerous control keys using a computer. The computer is connected to an Internet server and to an infrared emitter that makes it possible to emit control signals to the universal remote control so that the latter learns the codes of an original remote control that may be lost. The original remote control is replaced by reading the file on the Internet or on a backup disk. The universal remote control may be in a blank state before configuration. A number of learning variants are proposed. Iteratively, a key of the universal remote control and a control code are concurrently selected on the computer, this code then being transmitted to the universal remote control which stores it in relation to the selected key. In one embodiment that allows for easy and intuitive use, at least a part of the keyboard of the universal remote control is displayed on the computer screen. The user can then replace the press on the actual keys of the universal remote control with pointing to the virtual keys of the representation, the list of the controls possibly itself being replaced by an icon representation of the controls. It is therefore a matter of assigning, on each iteration, a preexisting command to a key.

The patent EP 1 058 921 describes the emulation of a universal remote control on a computer screen. This remote control (“Pronto”) has both mechanical keys (“Hard keys”) and a graphical user interface (GUI) based on a sensitive LCD screen, for the control of electronic equipment items such as television, video recorder, CD or DVD players, audio preamplifiers and tuners, etc. The computer is equipped with editing means making it possible to create or modify the configuration of the remote control, in particular of software buttons (“Soft Keys”) arranged on the graphical user interface. The sending of commands by the real remote control or by an emitter connected to the computer is possible when the mouse of the computer (or another means available to the user) activates the buttons on the screen emulating the real remote control.

U.S. Pat. No. 7,266,777 also describes the computer configuration of a remote control of the preceding type. Commands can be assigned both to the software buttons and to the mechanical keys. Four mechanical keys are in particular programmable to support macros or other functions to be configured. Through the use of a “drag and drop”, it is possible to select a command by its icon representation and assign it to one of the mechanical keys represented on a part of the screen of a computer.

The U.S. Pat. No. 6,211,870 describes a computer-programmable remote control with the aim of reducing the complexity of the existing devices. Although the prior art refers to a need to control not only multimedia equipment items but also home automation equipment items (lighting, air conditioning), the document is aimed exclusively at the multimedia equipment items.

It is known from the U.S. Pat. No. 6,791,467 to use a personal digital assistant (PDA) to remotely control a number of home automation equipment items in a dwelling. The equipment items are represented by icons on the sensitive screen of the PDA. When an equipment item is selected, a representation of its control panel appears on the sensitive screen. A press on a virtual key provokes the sending of the corresponding command.

The patent application US 2009/024778 also describes a remote control of PDA type that makes it possible to control numerous home automation equipment items. This document leaves a significant part to the user to configure, at his convenience, the numerous controls available to him, define “macro” type instructions concerning not only multimedia equipment items but also lighting or air conditioning equipment items, according to their location. The control keys are all virtual and can be configured on the graphical user interface of the PDA.

The U.S. Pat. No. 5,995,106 describes an intuitive graphical user interface, that makes it possible to view the icon representative of each controllable object on a screen background representative of its location. The programming of controls is performed by selecting the icon of the object and by selecting the remote control according to an animated wheel technique similar to the “cover flow” technique.

The U.S. Pat. No. 6,212,439 describes a personal computer provided with an auxiliary keyboard comprising 8 control keys and one menu key. A user not conversant with computing techniques may launch the execution of a specific computer program simply by pressing one of the control keys. Alternatively, the execution can be launched from a remote control that is not represented. In a configuration phase, the user assigns a program to a control key by selecting, on the computer screen, an icon of the program and dragging the latter to a button representative of a control key of the auxiliary keyboard. It is therefore a shortcut allowing for the activation of a computer program, chosen from several available programs installed in advance, from an auxiliary keyboard or from a remote control, and not of a functionality enabling the user to create his own control scenario.

With regard to home automation equipment items linked to the structure, the patent application FR 08/06940 describes a system comprising a control device provided with a screen that can be used in particular to view icons representative of equipment items. There is a step for setting a parameter of the equipment item as desired in the construction of the scenario, in which the parameter is adjusted: either by direct action on the equipment item with one of its control means, or by action on the control device by modifying the appearance of the icon representative of the equipment item.

Patent application EP 1 816 620 describes a roaming remote control that has at least one specific button allowing for the execution of a scenario whereas other buttons can be used to directly control the equipment items which are paired with the remote control. The press on the specific button provokes the sending of a specific command to a relay, which interprets this specific command as a scenario launch command and translates it into control commands to the various equipment items. The scenario is defined on the relay, which has a user interface provided with configuration buttons and a means of informing the user such as a screen.

The patent application FR 0957430 describes a programmable roaming remote control unit that has three keys and that can be used to activate a control scenario for a number of equipment items. This document does not describe the method implemented for the programming of the roaming remote control.

Apart from the preceding two documents, the documents of the prior art therefore describe: either simple roaming universal remote controls, that include only a few mechanical keys for control purposes, but intended only to reproduce existing controls of multimedia equipment items remote controls, or programmable roaming remote controls that are less complex because they are provided with a graphical user interface.

There is, however, a need for easy control of the equipment items linked to the structure in a dwelling. An occupant of a house does not in any way have the same behavior with regard to multimedia equipment items and with regard to equipment items linked to the structure: generally, the occupant accepts a certain complexity in the former case whereas he rejects it in the latter, even when accustomed to computing techniques. An explanation can be found in the paradox: “the more durable the equipment, the simpler it should be to use”.

More, elderly people may seek assistance from an installer or from one of their children to configure a remote control according to their wishes, but it is essential for this remote control to be as simple as possible. In particular, a screen is barely tolerated for the display (in large characters) of messages. Lamps are more accepted for feedback that is as simple as possible (green: correct execution of the command, red: problem).

Finally, a very easy control of the equipment items makes it possible to envisage a lower cost for the programmable roaming remote control. In this case, a number of programmable roaming remote controls may be installed in the dwelling. A programmable remote control is then assigned to each room in which different types of equipment items linked to the structure may be controlled simultaneously in the form of a scenario. Thus, the simplicity of use originates from the fact of finding, in each room, the remote control suited to security or comfort scenarios for which the need may be felt only in the room concerned.

### SUMMARY OF THE INVENTION

According to the invention, the method of controlling an installation formed by a plurality of home automation equipment items linked to a building, and handling therein, depending on the type of home automation equipment item, thermal and visual comfort functions, such as heating and air conditioning, natural ventilation, lighting, solar protection functions, and/or security functions, such as closure and/or alarm functions, the home automation equipment items communicating over one and the same home automation network, comprises:
a step for connecting, to a programming tool, a programmable remote control provided with a means of communication with the home automation network and provided with a command interface comprising only one or more mechanical keys, including at least one scenario execution key,
an installation discovery step, in which identifiers of the home automation equipment items of the installation are supplied to the programming tool,
a step for defining, in the programming tool, a control scenario involving a number of home automation equipment items, called scenario equipment items,
a step for assigning the control scenario to a scenario execution key,
a step for the standalone use of the programmable remote control, in which control commands defined in the control scenario are sent, from the programmable remote control to the scenario equipment items, following a press on the scenario execution key
   and, in the step for standalone use of the programmable remote control, commands to stop execution of the control scenario are sent, from the programmable remote control to the home automation equipment items of the scenario, in the event of a stop press on a mechanical key taking place during a scenario execution duration (T0).

According to the invention, in the discovery step, the programming tool can use the communication means of the programmable remote control to send a discovery request and to receive the identifiers of the home automation equipment items supplied by the home automation equipment items of the installation.

According to the invention, if the programmable remote control has a specific key, dedicated to the sending of stop commands, the stop press on this key may cause stop commands to be sent, including after the scenario execution duration.

According to the invention, the scenario execution stop commands may be stop commands when they relate to a movement actuator of a home automation equipment item, and may be state change commands when they relate to a lighting actuator of a home automation equipment item.

According to the invention, the scenario execution stop commands may be adapted according to the time (T1) separating an execution start and a stop press and/or according to the duration (T2) of the stop press.

According to the invention, the step for defining the control scenario may comprise:
the display, on a graphical user interface of the programming tool, of equipment and/or equipment group icons, each equipment icon being representative of one of the home automation equipment items for which the programming tool has received the identifiers and each equipment group icon being representative of a predefined group of home automation equipment items of the same type for which the programming tool has received the identifiers,
the selection of a control command,
the selection of an equipment icon, or of several equipment icons, or of an equipment group icon,
the formation of a control instruction comprising both the control command and the identifier of the home automation equipment item associated with the equipment icon or the identifiers of the home automation equipment items associated with the equipment or equipment group icons,
the storage of the control instruction in a list of control instructions involving several equipment items and constituting the control scenario.

According to the invention, the scenario definition step may also include the display, on the graphical user interface, of a scenario icon assigned to the list of instructions constituting the scenario.

According to the invention, the step for assigning the control scenario to one of the scenario execution keys may comprise:
the transfer, from the programming tool to the programmable remote control, of the control scenario, and
the storage of the control scenario in a scenario memory of the programmable remote control,
this transfer also including an identifier of the scenario execution key and this storage using the identifier of the scenario execution key to address the scenario memory, when the programmable remote control has more than one scenario execution key.

According to the invention, the transfer of the control scenario may be preceded by a virtual assignment of the control scenario to the scenario execution key, comprising:
the display of a representation of the scenario execution keys on the graphical interface, in addition to the scenario icon, a graphical interface software button corresponding to each representation of a scenario execution key,
a common selection of the scenario icon and of a software button.

According to the invention, a step for connecting to a programming tool may include the transfer of a control scenario from the programmable remote control to the programming tool when a programmable remote control has already undergone a step for assigning the control scenario to one of the scenario execution keys.

According to the invention, the control method may include a preliminary step for transferring an authentication key, common to all the home automation equipment items of the installation, from a remote control already present in the installation to the programmable remote control.

According to the invention, the programmable remote control may have at most two scenario execution keys.

According to the invention, the programmable remote control is provided with a means of communication with a home automation network of an installation formed by a plurality of home automation equipment items linked to a building, and handling therein, depending on the type of home automation equipment item, thermal and visual comfort functions, such as heating and air conditioning, natural ventilation, lighting, solar protection functions and/or security functions, such as closure and/or alarm functions, said remote control implements the method as described above and is provided with:
means for connecting with a programming tool,
means for transmitting over the home automation network control commands originating from the programming tool,
means for storing a control scenario in a scenario memory, following receipt of the control scenario from the programming tool,
   it is provided with a control interface comprising only one or more mechanical keys including at least one scenario execution key, related to the scenario memory, it comprises processing logic means able to provoke the sending over the home automation network of control commands contained in the scenario memory related to a scenario execution key in the event of a press on a scenario execution key and the processing logic means are, in addition, such that a press on a mechanical key provokes the sending over the home automation network of stop commands terminating the execution of the scenario, in the event of a stop press on a mechanical key taking place during a scenario execution duration (T0).

According to the invention, the stop commands terminating the execution of the scenario may be movement stop commands addressed specifically to the movement actuators defined in the scenario or addressed to all the actuators known to the programmable remote control.

According to the invention, the processing logic means are, in addition, such that the stop commands terminating the execution of the scenario may be state change commands when they are sent to lighting home automation equipment items.

According to the invention, the scenario execution stop commands may be adapted according to the duration (T1) separating a start of execution and a stop press and/or according to the duration (T2) of the stop press.

According to the invention, the programmable remote control may have at most two scenario execution keys.

According to the invention, the processing logic means may be, in addition, such that a press on a scenario execution key provokes the sending over the home automation network of a specific command, as long as no control commands have been stored in the scenario memory.

### DESCRIPTION OF THE DRAWINGS

The invention will be better understood by those skilled in the art from the detailed description of a number of embodiments in conjunction with the associated drawings, in which:

FIG. 1 represents an installation, comprising a programmable remote control according to the invention, and a programming tool implementing the control method according to the invention.

FIG. 2 represents a first screen configuration of the programming tool.

FIG. 3 represents a second screen configuration of the programming tool.

FIG. 4 represents the control method according to the invention.

FIG. 5 represents a first variant and a second variant of the control method.

FIG. 6 represents a third variant and a fourth variant of the control method.

FIG. 7 represents a fifth, a sixth and a seventh variant of the control method.

### DESCRIPTION OF THE PREFERRED EMBODIMENTS

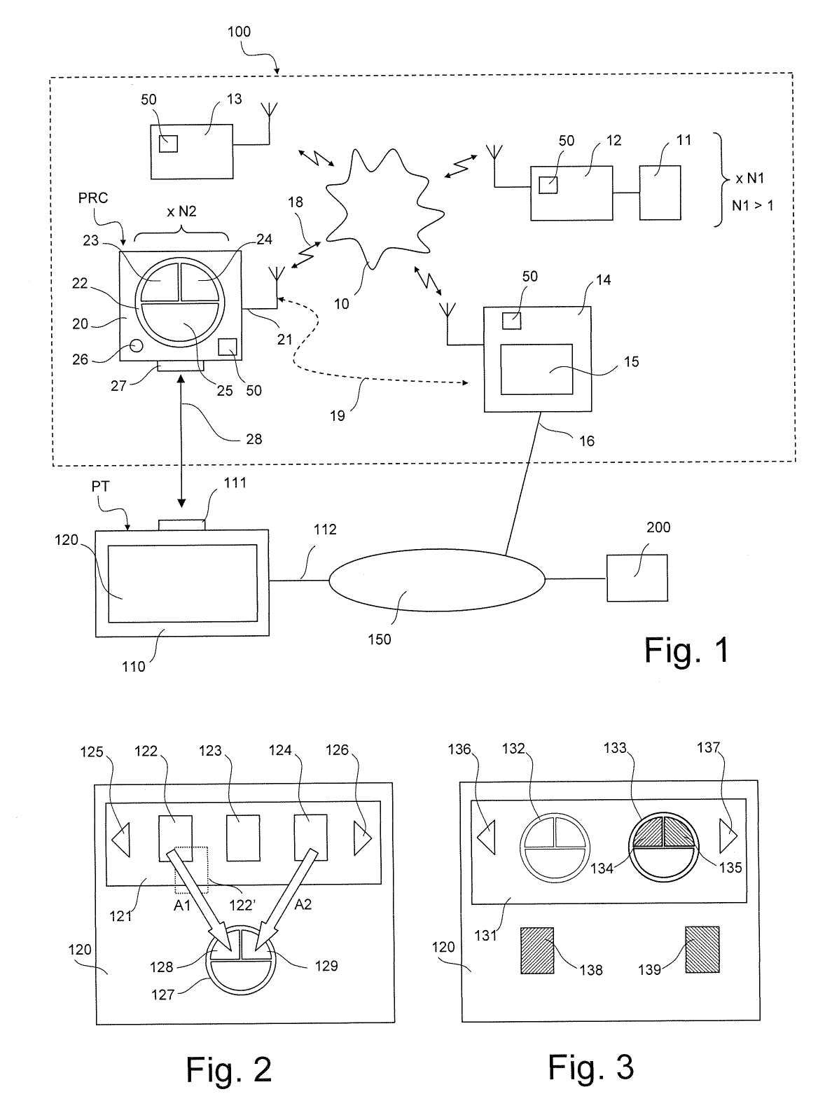

FIG. 1 represents an installation 100, comprising a programmable remote control 20 according to the invention and a programming tool 110 implementing the control method according to the invention.

The installation 100 comprises a home automation communication network 10 enabling communication between home automation equipment items and command emitters. The home automation communication network is preferably of wireless type, based on radiofrequency waves. Alternatively, any type of communication network may be used, for example by bearer currents over electricity distribution lines. A home automation equipment item 11 communicates over the home automation network using a command receiver 12. Preferably, the communication is of bidirectional type, in order to be able to send messages relating to the correct reception and/or the correct execution of the commands received. The installation comprises N1 (N1>1) home automation equipment items, only one of which is represented in the interests of simplicity. Depending on their type, the home automation equipment items provide, in a building, thermal and visual comfort functions (heating and air conditioning, natural ventilation, lighting, solar protection) and/or security functions (closures, alarm). Some home automation equipment items therefore include a movement actuator that is not represented. The installation also includes command emitters. A command emitter 13 emits control commands to the home automation equipment items using the home automation network. The command emitter is of roaming or wall-mounted remote control type, provided with control means that are not represented. Alternatively, the command emitter comprises a sensor, for example a weather, comfort, presence or security sensor. Preferably, the communication with a command emitter is of bidirectional type.

The installation comprises a gateway 14, provided with a touch screen 15, enabling communication to an Internet network 150 via a first Internet link 16. The touch screen is used, for example, to configure the gateway. The gateway may not have a touch screen if it is configured with another means, for example a PDA or a cell phone equipped with a Bluetooth communication means also located on the gateway.

Alternatively, the installation has no gateway. The invention applies in particular in the case where the installation has no gateway, but it is also beneficial in the case where a gateway is already present in the installation.

All the devices authorized to communicate over the home automation network share a common authentication key 50, stored in each device.

The installation finally comprises at least one programmable remote control 20 according to the invention.

It preferably comprises one or more programmable remote controls which may be assigned to different rooms and/or to different users.

The programmable remote control includes a means for communicating 21 with the home automation network. The exchanges with the home automation network are represented by double arrows 18.

Both for cost reasons and for ease of use reasons, the programmable remote control is therefore chosen to have the simplest possible structure. In particular, the control interface 22 of the remote control has only mechanical keys unambiguously creating a specific press sensation.

The expression “mechanical key” should be understood to mean a key whose activation is reflected by sensitive feedback on the finger of the user activating the key, this sensitive feedback being linked to a variation of the mechanical properties of the mechanical key (position, stiffness, etc).

For example, the sensitive feedback on the finger is provoked by the displacement of the key by pressure of the finger on the latter, a displacement that is detected by an electric or electronic circuit. An elastic means then returns the mechanical key to the rest position when the pressure ceases on the key.

Alternatively, but with a higher cost, another example of a mechanical key is that of a fixed key provided with a piezoelectric vibration means reproducing, through contact with the finger, the force and depression sensation. The piezoelectric vibration means serves both as sensor and emitter of the sensitive feedback on the finger of the user.

By contrast, a simple touch-sensitive key is not a mechanical key within the meaning of the invention. Similarly, a key representation on a touch screen, even if driven by light touch, is not a mechanical key.

A first mechanical key is a first scenario execution key 23. A second mechanical key is a second scenario execution key 24. A third mechanical key is a specific key 25, not used to control the execution of scenarios. The specific key is, for example, a common key used in particular to control the stopping of a scenario while it is executing.

Alternatively, the programmable remote control has only a single scenario execution key or, on the contrary, more than two scenario execution keys but preferably a limited number thereof to avoid risks of confusion. Similarly, the programmable remote control may have more than one specific key or, on the contrary, no specific key.

The programmable remote control has a display means, not used in any circumstances as a control means. It is, for example, one or more LEDs, or even a small screen for viewing simple pictograms. The programmable remote control also includes a storage means for the common authentication key 50.

Finally, the programmable remote control includes a means 27 for connecting, via a media 28, to a programming tool 110, not assigned to the installation but used for the programming of the programmable remote control. The medium 28 is preferably of wire type, based on the USB (Universal Serial Bus) or 12C standard. Alternatively, the medium is wireless, for example of infrared (IRDA) or radiofrequency (Bluetooth) type.

The programming tool is a personal computer, for example of tablet type. It includes a means 111 of connecting to the medium 28 and a graphical user interface (GUI) 120 of touch screen type. Alternatively, the graphical user interface comprises a screen, a keyboard and/or a means of pointing, such as a mouse, to objects on the screen.

The programming tool also includes a second Internet link 150 providing access to resources on the Internet network.

To illustrate steps of the method described hereinbelow, FIG. 2 represents a first screen configuration of the programming tool. This first configuration is used when virtually assigning a control scenario to each of the scenario execution keys of the programmable remote control.

A first scrolling window 121 of the graphical user interface shows scenario icons 122-124 relating to control scenarios stored in the programming tool. Each icon represents a list of control instructions comprising control commands previously assigned to various home automation equipment items of the installation.

A first scenario icon 122 relates to a first control scenario. A second scenario icon 123 relates to a second control scenario. A third scenario icon 124 relates to a third control scenario. Other control scenarios may have been stored in the programming tool. A first left scroll button 125 can be used to drag scenario icons to the left, the first icon 122 disappearing and a new icon appearing in the space previously occupied by the third icon 124. Conversely, a first right scroll button 126 can be used to provoke a scrolling of the icons to the right.

Preferably, a control scenario name is associated with each scenario icon.

Thus, the programming tool is able to store and to display as icons a large number of scenarios defined by the user. The scenarios are stored durably in a non-volatile memory of the programming tool, or associated with the programming tool (external hard disk, optical disk, USB key). Alternatively, the storage can be done on an external server 200 linked to the Internet network 150.

The graphical user interface 120 also shows a representation of the control interface 127 of the programmable remote control during programming. This representation has associated with it a first software button 128 and a second software button 129, each software button respectively covering the representation of each scenario execution key. The common selection of a scenario icon and of a software button provokes the storage, in the programming tool, of a link between the list of commands of the scenario and an identifier of the scenario execution key. The scenario is then virtually assigned to the scenario execution key.

Preferably, the simultaneous selection takes place through a “drag and drop” type action, as represented by the arrow A1: the finger of the user touches the touch screen at the level of the first scenario icon 122, which selects it, then drags on the screen, accompanied by a duplicate 122′ of this icon, until the duplicate of the icon is dropped onto the first software button 128, which selects it. Similarly, an action A2 of “drag and drop” type can be used to virtually assign the third control scenario to the second scenario execution key by selecting the third scenario icon 124 and by dragging its duplicate onto the second software button 129.

FIG. 3 represents a second screen configuration of the programming tool, also illustrating the method described below.

A second scrolling window 131 of the graphical user interface 120 shows programmable remote control icons 132 and 133. Preferably, a name is associated with each programmable remote control to explain who its user is or to which room of the building it is assigned.

A second left scroll button 136 can be used to provoke a dragging of the remote control icons to the left. Conversely, a secondly right scroll button 137 can be used to provoke a scrolling of the icons to the right.

When a remote control icon is selected, for example by pressing the finger on the touch screen at the level of this icon, the latter appears highlighted and the scenario icons assigned to each scenario execution key are also displayed on the screen. Thus, the remote control icon 133 being selected, the graphical user interface 120 displays a fourth scenario icon 138 corresponding to a control scenario assigned to a first scenario launch key 134 of this remote control and displays a fifth scenario icon 139 corresponding to a control scenario assigned to a second scenario launch key 135 of this remote control.

Thus, the programming tool is capable of storing and displaying as icons a large number of programmable remote controls programmed by the user. The information is stored durably as previously described.

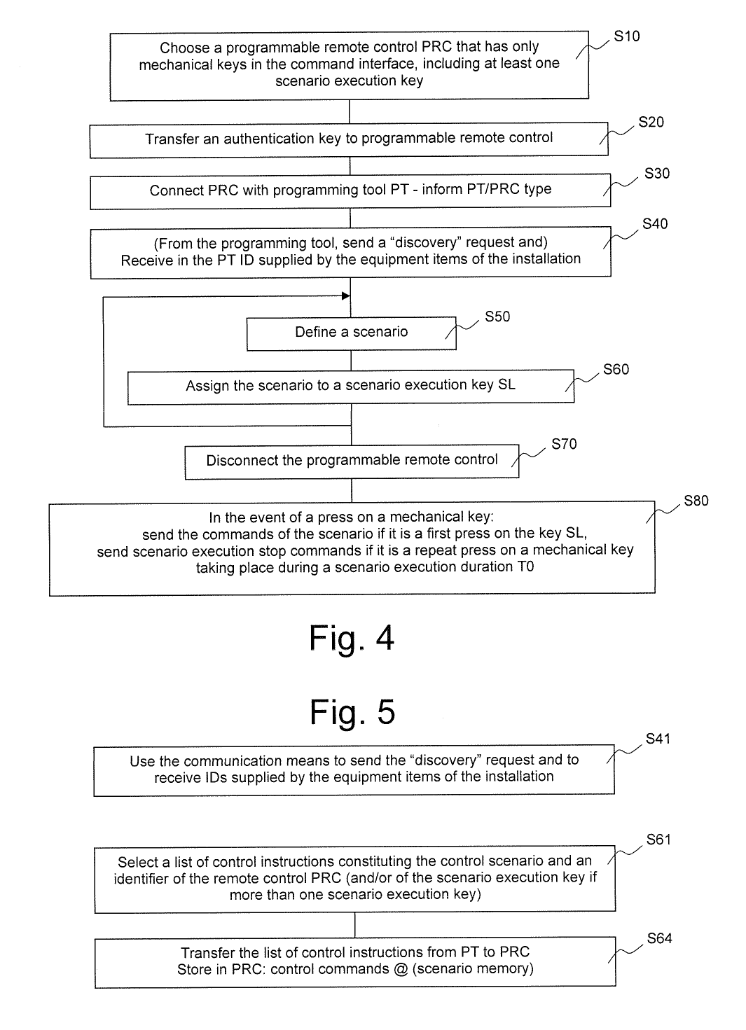

FIG. 4 represents, in the form of a sequence of steps, the control method according to the invention.

In a first step S10, at least one programmable remote control 20, denoted PRC, is chosen, that has the characteristics described above. In a second step S20, the authentication key common to the devices of the installation is transferred to the programmable remote control. Preferably, this key transfer takes place by communication over the home automation network between the command emitter 13, which already has the common authentication key 50, and the programmable remote control 20. The key transfer may be secured by requiring a command receiver to participate in the key transfer operation.

In a third step S30, the programmable remote control is connected to a programming tool, denoted PT. Preferably, this connection is by wire using USB connectors of the programmable remote control and of the programming tool. The type and an identifier ID' of the programmable remote control are then transmitted to the programming tool.

Having confirmed the presence of the connection, the programming tool provokes, in a fourth step S40, the sending over the home automation network of a discovery request. Alternatively, this request is sent by the programmable remote control when it confirms its connection to the programming tool. In all cases, the identifiers ID of each home automation equipment item of the installation, in response to the discovery request, are received and stored in the programming tool.

At this stage, the programming tool has a list of equipment items of the installation. It also has information on the type of programmable remote control and on its identifier. Furthermore, the programming tool has a list of commands and/or contains routines for virtually modifying the parameters of an equipment item of a given type and for determining control commands to be sent to this equipment item to modify said commands. All these routines are contained in processing software of the programming tool or are contained in a database that can be accessed by the programming tool, for example the server 200.

In a fifth step S50, a control scenario is defined.

In a sixth step S60, the control scenario is assigned to one of the scenario execution keys of the programmable remote control. The fifth and/or the sixth step are performed using the methods described in the prior art and/or, preferably, by using the variables described hereinbelow.

These steps are repeated for different scenario execution keys corresponding to the type of programmable remote control used.

In a seventh step S70, the programmable remote control is disconnected, either by disconnecting a wired connection, or by terminating a wireless connection. Its standalone use is then permitted.

In this standalone use, described by an eighth step S80, a press on a scenario execution key provokes the sending, to different equipment items of the installation, of control commands defined in the scenario assigned to this key. However, a new press on a mechanical key that occurs during a scenario execution duration T0 is considered as a stop press and provokes the sending of commands terminating the execution of the scenario. The scenario execution duration can be set by a predetermined timer, for example 15 seconds or 30 seconds depending on the normal longest duration for execution of a command by a home automation equipment item. The predetermined timer is, for example, activated upon the sending of the first control commands of the scenario.

Preferably, the scenario execution duration begins with the sending of the first control commands of the scenario and ends with the receipt by the programmable remote control of a final message confirming correct command execution on the part of a final equipment item involved in the scenario.

A stop press is therefore a press on one of the scenario execution keys of any duration but occurring during the scenario execution duration.

A stop press is also a press on a specific key, dedicated to the sending of stop commands. A press on this specific key may provoke the sending of stop commands, even if it takes place after the scenario execution duration. However, a new press on a scenario execution key provokes the sending of stop commands only if this press occurs during the scenario execution duration T0.

Thus, beyond this duration, the scenario execution key becomes available again to control the execution of the scenario.

The benefit of having a specific key dedicated to the sending of stop commands is that it makes it possible to send stop commands to home automation equipment items activated by another remote control or by an automated control device. It is then possible at any instant to send stop commands to all the home automation equipment items known to the programmable remote control.

All of the method is repeated for different programmable remote controls intended to be used in the installation. Alternatively, some steps are reversed (for example, the second and third steps), or grouped together (for example, the first and third steps), or else the scenario execution step is repeated over a plurality of scenarios, each scenario being thereafter assigned to a scenario execution key of one or more programmable remote controls, as represented in FIGS. 2 and 3.

The control method is preferably used in combination with the following variants.

FIG. 5 represents a first variant and a second variant of the control method.

The first variant comprises a substep S41 of the fourth step. Preferably, it is the communicating means of the programmable remote control PRC which is used by the programming tool to provoke the sending of the discovery command and at least to provoke the reception of the identifiers ID of the equipment items of the installation. Thus, the programming tool PT does not need to have specific means of communication with the home automation network.

Complementing this first variant, the second authentication key transfer step may be provoked, on the programmable remote control, by a command from the programming tool if the second and third steps are reversed. This way, it is pointless for the programmable remote control to be fitted with a dedicated key on entry into an authentication key transfer mode.

The second variant comprises the sequencing of two substeps S61 and S64 of the sixth step of the method. In a first substep S61, a control scenario is selected that comprises, in the form of lists or tables, the control instructions of the control scenario (each control command having an associated identifier of the home automation equipment item affected by this control command to form a control instruction), and an identifier of the programmable remote control and an identifier of the scenario key if the programmable remote control has more than one scenario execution key. In a fourth substep S64, the instructions of the control scenario are transferred from the programming tool PT to the programmable remote control PRC and are stored therein in a scenario memory. When the remote control has more than one scenario execution key, the storage address of the control instructions of the scenario in the scenario memory takes account of the identifier of the scenario execution key.

When the control instructions include only identifiers of the equipment items (case treated hereinbelow in relation to FIG. 7), the storage of these recipient identifiers may take place in a common memory of the programmable remote control.

During tests of the control scenario, for example before the start of the seventh step, the control commands of the scenario may similarly be sent by the communication means, following an execution command of the scenario provoked on the programming tool, or else following the direct activation of a mechanical key.

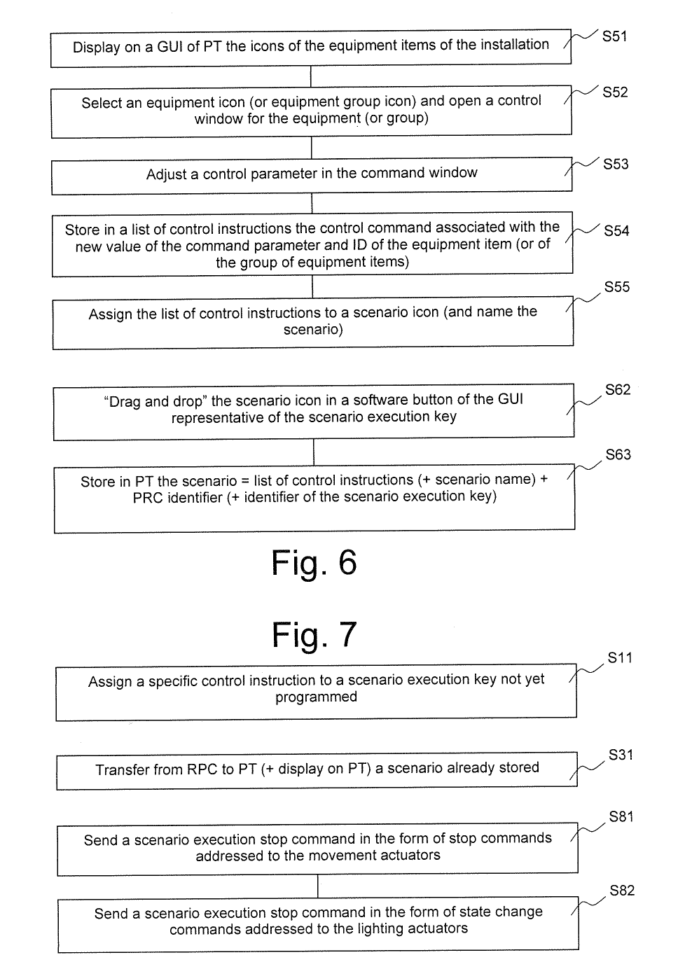

FIG. 6 firstly represents a third variant of the control method, relating to the fifth step and specifying the preferred mode for defining a control scenario using icons. In a first substep S51, icons representative of each equipment item of the installation are displayed on the screen of the graphical user interface. These icons appear in generic form, with an icon graphic for each type of equipment item, and with an equipment name associated with the icon, the name making it possible for the user to locate the equipment item in his environment. The name of each equipment item has been transmitted by the equipment item in response to the discovery request. Alternatively, the equipment icon is representative of the current state of the equipment (open, closed, intermediate position, etc.).

In this substep, it is also possible to construct groups of equipment items of the same type, by associating with them one and the same equipment group icon and by naming this group of equipment items.

Alternatively, the equipment items have themselves communicated, during the discovery step, an information item relating to their individual membership to one or more groups of equipment items.

In a second substep S52, the user selects an equipment icon, for example by a finger press on the touch screen on the icon. This action causes an equipment item control window to open. The equipment item control window shows the equipment item in as much detail as possible, notably with one or more buttons for setting a parameter of the equipment item: for example, for a venetian blind, a button for setting the orientation of the slats of the blind and a button for setting the deployment of the apron.

In a third substep S53, at least one of the parameters is adjusted, virtually, by acting on the corresponding setting button. In a fourth substep S54, the control command, or the control commands, used to obtain the desired parameter value are stored in a list of commands, related to the identifier of the home automation equipment item.

In a fifth substep S55, this list of commands is assigned to a scenario icon. A number of scenario icon models are made available to the user who chooses one and assigns it the name of his choice.

These four substeps may similarly be applied simultaneously to a number of icons of equipment items of the same type, that have been the subject of a common selection or else to an equipment group icon.

FIG. 6 also represents a fourth variant of the control method, relating to the sixth step and specifying the method of assigning a control scenario to a scenario execution key, using icons. In a second substep S62, following the first substep S61 of FIG. 5 or replacing the latter, a scenario icon as created as explained above, then a software button of the graphical user interface representative of a scenario execution key are selected using an action to “drag and drop” the scenario icon into the software button. Following this common selection action by the user, a third substep S63 causes a link between the list of control instructions of the scenario and the identifier of the scenario execution key to be stored in the programming tool.

If the programmable remote control has only a single scenario execution key, the identifier of the scenario execution key is, for example, replaced with the identifier of the programmable remote control. On completion of this substep, the control scenario is virtually assigned to the scenario execution key. The third substep S63 then precedes the fourth substep S64 of FIG. 5, in which the virtual assignment becomes real assignment.

FIG. 7 represents a fifth, a sixth and a seventh variant of the control method.

The fifth variant comprises a preliminary substep S11 relating to the choice of the state of the programmable remote control before its programming. In this substep, performed for example at the programmable remote control manufacturing stage, a predetermined specific command is assigned to a scenario execution key not yet programmed with a programming tool. This specific command may include simply a key identifier, which will be sent when the key is pressed. In this case, the programmable remote control may very well be used directly, without programming other than a pairing, to control an equipment item (or a group of equipment items) to which this remote control would be paired. Preferably, the programmable remote control may be used with an equipment item of the installation serving as a relay and able to launch the execution of a scenario on receipt of a command from the programmable remote control, as described in the patent application EP 1 816 620. The gateway 14 is, for example, this type of equipment item and the dotted-line link 19 explains this mode of operation in FIG. 1.

Thus, one and the same programmable remote control may be used to execute a scenario programmed by the user and assigned to a scenario execution key:
either by storage of the commands of the scenario in the remote control itself,
or by storage of the commands of the scenario in a device of the installation used as a relay, and provided, for example, with its own scenario definition means.

This variant therefore gives great flexibility of use of the programmable remote control, depending on the degree of equipment of the installation in which it is inserted. Obviously, a reinitialization process makes it possible to restore a programmable remote control already previously programmed to an “unprogrammed” state defined by the substep S11.

In the same way, the programmable remote control alternatively has an original “unprogrammed” state, identical to that of a non-programmable remote control. For example, each of three mechanical scenario execution keys is initially assigned to a single control command during manufacture: a raise command, a stop command, a lower command. The programming tool is then used either to fully modify the content of the scenario memory in relation to the scenario execution keys, as described previously by the method of the invention, or to simply assign to each remote control a list of recipient equipment identifiers or a recipient group identifier, as is known from the prior art. In this case, the transfer from the programming tool to the programmable remote control includes only data relating to the these identifiers, which can be stored within the programmable remote control in a common memory, separate from the scenario memory.

The sixth variant comprises a substep S31 relating to the connection of the programmable remote control with a programming tool. During this connection, a scenario already stored in the programmable remote control is transmitted to the programming tool, if this programmable remote control has already been the subject of a prior programming. The scenario is displayed on the programming tool. On the graphical user interface of the programming tool, the programmable remote control (and the associated scenario icons) appears, for example, highlighted as represented in FIG. 3, but on its own. This variant makes it possible, for example, to edit an existing control scenario to make a few modifications to it.

The seventh variant comprises three substeps specifying the eighth step, during standalone operation of the programmable remote control.

In a first substep S81, the scenario execution stop command comprises the sending of stop commands to the equipment items that include movement actuators involved in the scenario currently being executed.

In a second substep S82, the scenario execution stop command comprises the sending of a state change command, for example, a “toggle” command, to the home automation equipment items that include lighting actuators involved in the scenario currently being executed. If the lighting actuator is indeed controlled simply in a powered state and an unpowered state, the execution of the command is immediate. Stopping execution of the scenario usually entails a return to the prior state to mitigate a discomfort felt during execution of the scenario. For example, when the user has activated the execution of an “energy saving” scenario without realizing that he would immediately be in darkness, it is necessary that the stopping of execution of the scenario also restores the lighting of the room.

The first substep S81 may be implemented in the control method without the second substep S82 being implemented.

The stopping of the execution of a scenario responds to a new command from the user which may be interpreted in different ways, notably according to the reaction time of the user, that is to say, the duration T1 that elapses between the start of execution and the new press on a mechanical key or stop press.

To this end, a third substep S83 adapts the nature of the scenario execution stop command according to this reaction time.

For example, an almost immediate reaction, that is to say, a reaction time less than, for example, a threshold of 2 seconds, reveals a manipulation error on the part of the user when launching the scenario. For example, the user finds that he has activated the first scenario execution key whereas he wanted to execute the second scenario execution key.

In the case of short reaction time, it is therefore best not only to terminate the commands currently being executed, but also to restore all the home automation equipment items to their initial state. The scenario execution stop command then includes state change commands allowing for this return to the initial state of all the equipment items.

In the case of a long reaction time, it means, for example, that the user estimates that he has reached the desired level of comfort, without the scenario being executed to its end. This case may notably occur when movement actuators are incorporated in solar protection home automation equipment items whose movement is slow, either because of the nature of the equipment item, or because of a deliberately gradual adjustment. The optimum comfort level is not necessarily that which corresponds to the complete execution of the scenario. In this case, it is important for the scenario execution stop command to affect only the movement actuators, and it is important not to provoke any change of state on the lighting actuators.

Alternatively, or in addition to the evaluation of the reaction time of the user, the adaptation of the scenario execution stop command is done by evaluating the duration T2 of the stop press on the mechanical key in the substep S83. A short stop press duration, for example less than 1 second, is interpreted as having simply to give rise to stop commands, whereas a long stop press duration, for example greater than 1 second, is interpreted as having to give rise not only to stop commands but also to commands enabling the return to the initial state.

1. A method of controlling an installation formed by a plurality of home automation equipment items linked to a building, and handling therein, depending on the type of home automation equipment item, thermal and visual comfort functions, such as heating and air conditioning, natural ventilation, lighting, solar protection functions, and/or security functions, such as closure and/or alarm functions, the home automation equipment items communicating over one and the same home automation network, wherein it comprises:
a step for connecting, to a programming tool, a programmable remote control provided with a means of communication with the home automation network and provided with a command interface comprising only one or more mechanical keys, including at least one scenario execution key,
an installation discovery step, in which identifiers of the home automation equipment items of the installation are supplied to the programming tool,
a step for defining, in the programming tool, a control scenario involving a number of home automation equipment items, called scenario equipment items,
a step for assigning the control scenario to a scenario execution key,
a step for the standalone use of the programmable remote control, in which control commands defined in the control scenario are sent, from the programmable remote control to the scenario equipment items, following a press on the scenario execution key
and in that, in the step for standalone use of the programmable remote control, commands to stop execution of the control scenario are sent, from the programmable remote control to the home automation equipment items of the scenario, in the event of a stop press on a mechanical key taking place during a scenario execution duration (T0).

2. The control method as claimed in claim 1, wherein, in the discovery step, the programming tool uses the communication means of the programmable remote control to send a discovery request and to receive the identifiers of the home automation equipment items supplied by the home automation equipment items of the installation.

3. The control method as claimed in claim 1, wherein, if the programmable remote control has a specific key, dedicated to the sending of stop commands, the stop press on this key causes stop commands to be sent, including after the scenario execution duration.

4. The control method as claimed in claim 1, wherein the scenario execution stop commands are stop commands when they relate to a movement actuator of a home automation equipment item, and are state change commands when they relate to a lighting actuator of a home automation equipment item.

5. The control method as claimed in claim 1, wherein the scenario execution stop commands are adapted according to the time (T1) separating an execution start and a stop press and/or according to the duration (T2) of the stop press.

6. The control method as claimed in claim 1, wherein the step for defining the control scenario comprises:
the display, on a graphical user interface of the programming tool, of equipment and/or equipment group icons, each equipment icon being representative of one of the home automation equipment items for which the programming tool has received the identifiers and each equipment group icon being representative of a predefined group of home automation equipment items of the same type for which the programming tool has received the identifiers,
the selection of a control command,
the selection of an equipment icon, or of several equipment icons, or of an equipment group icon,
the formation of a control instruction comprising both the control command and the identifier of the home automation equipment item associated with the equipment icon or the identifiers of the home automation equipment items associated with the equipment or equipment group icons,
the storage of the control instruction in a list of control instructions involving several equipment items and constituting the control scenario.

7. The control method as claimed in claim 6, wherein the scenario definition step also includes the display, on the graphical user interface, of a scenario icon assigned to the list of instructions constituting the scenario.

8. The control method as claimed in claim 1, wherein the step for assigning the control scenario to one of the scenario execution keys comprises:
the transfer, from the programming tool to the programmable remote control, of the control scenario, and
the storage of the control scenario in a scenario memory of the programmable remote control,
this transfer also including an identifier of the scenario execution key and this storage using the identifier of the scenario execution key to address the scenario memory, when the programmable remote control has more than one scenario execution key.

9. The control method as claimed in claim 7, wherein the transfer of the control scenario is preceded by a virtual assignment of the control scenario to the scenario execution key, comprising:
the display of a representation of the scenario execution keys on the graphical interface, in addition to the scenario icon, a graphical interface software button corresponding to each representation of a scenario execution key,
a common selection of the scenario icon and of a software button.

10. The control method as claimed in claim 8, wherein a step for connecting to a programming tool includes the transfer of a control scenario from the programmable remote control to the programming tool when a programmable remote control has already undergone a step for assigning the control scenario to one of the scenario execution keys.

11. The control method as claimed in claim 1, wherein it includes a preliminary step for transferring an authentication key, common to all the home automation equipment items of the installation, from a remote control already present in the installation to the programmable remote control.

12. The control method as claimed in claim 1, wherein the programmable remote control has at most two scenario execution keys.

13. A programmable remote control provided with a means of communication with a home automation network of an installation formed by a plurality of home automation equipment items linked to a building, and handling therein, depending on the type of home automation equipment item, thermal and visual comfort functions, such as heating and air conditioning, natural ventilation, lighting, solar protection functions and/or security functions, such as closure and/or alarm functions, said remote control implementing the method as claimed in claim 1 and being provided with:
means for connecting with a programming tool,
means for transmitting over the home automation network control commands originating from the programming tool,
means for storing a control scenario in a scenario memory, following receipt of the control scenario from the programming tool,
wherein it is provided with a control interface comprising only one or more mechanical keys including at least one scenario execution key, related to the scenario memory, and in that it comprises processing logic means able to provoke the sending over the home automation network of control commands contained in the scenario memory related to a scenario execution key in the event of a press on a scenario execution key and in that the processing logic means are, in addition, such that a press on a mechanical key provokes the sending over the home automation network of stop commands terminating the execution of the scenario, in the event of a stop press on a mechanical key taking place during a scenario execution duration (T0).

14. The programmable remote control as claimed in claim 13, wherein the stop commands terminating the execution of the scenario are movement stop commands addressed specifically to the movement actuators defined in the scenario or addressed to all the actuators known to the programmable remote control.

15. The programmable remote control as claimed in claim 13, wherein the processing logic means are, in addition, such that the stop commands terminating the execution of the scenario are state change commands when they are sent to lighting home automation equipment items.

16. The programmable remote control as claimed in claim 13, wherein the scenario execution stop commands are adapted according to the duration (T1) separating a start of execution and a stop press and/or according to the duration (T2) of the stop press.

17. The programmable remote control as claimed in claim 13, wherein it has at most two scenario execution keys.

18. The programmable remote control as claimed in claim 13, wherein the processing logic means are, in addition, such that a press on a scenario execution key provokes the sending over the home automation network of a specific command, as long as no control commands have been stored in the scenario memory.

19. The control method as claimed in claim 8, wherein the transfer of the control scenario is preceded by a virtual assignment of the control scenario to the scenario execution key, comprising:
the display of a representation of the scenario execution keys on the graphical interface, in addition to the scenario icon, a graphical interface software button corresponding to each representation of a scenario execution key,
a common selection of the scenario icon and of a software button.
